(19) United States
(12) Patent Application Publication
(10) Pub. No.: US 2003/0140457 A1
(43) Pub. Date: Jul. 31, 2003

(54) Turning structure with turning member and base member

(76) Inventor: Makoto Kida, Yokohama-shi (JP)

Correspondence Address: HOGAN & HARTSON L.L.P., 500 S. GRAND AVENUE, SUITE 1900, LOS ANGELES, CA, 90071-2611, US

(21) Appl. No.: 10/339,913

(22) Filed: Jan. 10, 2003

(30) Foreign Application Priority Data
Jan. 25, 2002 (JP) 2002-056630
Apr. 1, 2002 (JP) 2002-099233
Nov. 13, 2002 (JP) 2002-329996

(51) Int. Cl. E05C 17/64

(52) U.S. Cl. 16/342

(57) ABSTRACT

A turning structure according to the present invention is used in note-size personal computers having a computer body 2 as a base member and a top cover 3. The turning structure is made up of a first hinge 21 and a second hinge 22. The first hinge 21 is provided with a friction member 24 to provide frictional resistance to the top cover 3 against its turn relative to the computer body 2. The second hinge 22 is provided with a torsion coil spring 73 to urge the top cover 3 relative to the computer body 2 so as to counter the rotation moment acting on the top cover 3 by its own weight when the top cover 3 turns relative to the computer body 2.

### CROSS-REFERENCE TO RELATED APPLICATIONS

The entire disclosure of Japanese patent applications No. 2002-056630 filed on Jan. 25, 2002, No. 2002-099233 filed on Apr. 1, 2002, and No. 2002-329996 filed on Nov. 13, 2002, including their specification, claims, drawings, and summary is incorporated herein by reference.

### BACKGROUND OF THE INVENTION

1. Field of the Invention

This invention relates to a turning structure made up of a turning member and a base member, such as the main part and the top cover of portable information processing devices such as personal computers (PCs), the main part and the lid of electric apparatuses, etc.

2. Prior Art

The turning structure consisting of a base member and a turning member is conventionally known for example as the hinge device for supporting the top cover, of the note-size PCs, to be opened and closed by swing-turning motion. The hinge device consists of a friction member made of a plastic material in which a tapered hole is formed for receiving a tapered metallic rotary shaft. The friction member and the rotary shaft are tightened up together with a considerable force using a nut screwed onto the thread portion of the rotary shaft, so that the friction member has spring function to produce an appropriate rotary frictional force and an appropriate holding force. Since this type of hinge device is arranged to produce spring function with the deformation of the friction member by tightening up together the friction member and the turning shaft, an advantage is that a sufficient rotary frictional force for the holding force is obtained with a structure of a small size. (For example, refer to the patent literature #1)

[Literature #1]

JP-A-2000-356214

The hinge device for the top cover of a note-size PC supports both end portions of the turning base edge of the top cover for swing opening and closing motion, in the state of the top cover being a cantilever so to speak. Since a liquid crystal display monitor and others are attached to the top cover, the hinge device is required of a relatively large holding force to stop and hold the top cover having a relatively large weight at any angle. Therefore, it has been conventionally necessary to set the resisting force for holding the top cover, or the frictional force, to a large value. As a result, the hinge device has been conventionally tightened up with a considerably large force using nuts. Therefore, the hinge device is constantly under loads, which is a factor of lowering the durability of the hinge device. An attempt of increasing the durability of the hinge device ends up in the increase in the size of the hinge device itself.

On the other hand, the note-size PC of late is required to have a large top cover while the weight of the PC as a whole is required to be light, and that tendency seems to have gone to a considerable extent. As a result, the PC itself is considerably light. Therefore, if the frictional force of the hinge device is set to a large value and one attempts to open the top cover quickly, the main part of the PC on the keyboard side is sometimes lifted up together with the top cover. From this viewpoint, smaller the frictional force of the hinge device, the more preferable.

However, a relatively large holding force has been conventionally required to hold the heavy top cover, having a liquid crystal display monitor and others in a cantilever state, at any swing opening angle. On the other hand, it is preferable that the force for opening and closing operation of the top cover be small and constant for smooth opening and closing actions.

From another aspect, the force for opening and closing the top cover varies with the angular position of the top cover. That is to say, at the start of opening up the top cover, the center of gravity of the top cover is horizontally farthest from the turning shaft center and so the rotation moment by the top cover weight is the greatest. Therefore, the top cover is heavy to open up against the rotation moment at the start of the opening action. In contrast, at the start of closing the top cover from the opened up position, the rotation moment by the top cover weight is small. In the course of closing the top cover, the rotation moment by the top cover's own weight increase gradually and adds to the force of the closing action. Therefore, even if one intends to keep the closing action force constant, the top cover is accelerated to the point just before being closed completely, and is closed often at a fast speed. In other words, the opening and closing action of the top cover is hard to control by hand, or the operability in opening and closing action is poor.

On the other hand, since the conventional hinge device requires a holding force for stopping and holding the top cover at any angle, the frictional resistance in opening and closing the top cover must be increased. However, the increase in the frictional resistance makes it hard to open and close the top cover, and is likely to damage the hinge device and to cause hinge troubles. Hinge troubles in use not only make it impossible to obtain necessary frictional force for holding the top cover having the liquid crystal display monitor at any position but also increase the frictional force and bring about a situation in which the PC's main part on the keyboard side is lifted together with the top cover when one attempts to open it up.

### DISCLOSURE OF THE INVENTION

An object of the present invention is to provide a turning structure with a turning member and a base, capable of solving the above problems, preventing the turning member from swinging down by itself toward the base side by the weight of the turning member itself, and facilitating the swing operation of the turning member.

Another object of the present invention is to provide a top cover opening and closing device for portable information processing apparatuses, that makes it possible to open and close the top cover of the portable information processing apparatuses smoothly with a light, stabilized force.

Still another object is, when a hinge device is employed that utilizes friction, to provide a top cover opening and closing device for portable information processing apparatuses, that makes it possible to reduce the frictional holding force and to elongate the service life of the device for opening and closing the top cover that supports the top cover.

Still another object of the present invention is to provide a top cover opening and closing device for portable information processing apparatuses, that can be used with ease to open and close the top cover utilizing the power source such as a small electric motor or the like.

The turning structure with a turning member and a base member according to the present invention is arranged that the turning member is attached for free turning to the base member so that the turning member can be operated to turn, and is provided with an urging means for urging the turning member relative to the base member and a driving mechanism for turning the turning member by the use of power.

The urging means is to urge the turning member relative to the base member when the turning member turns relative to the base member, to create, in at least part of the possible turning range of the turning member relative to the base member, a region in which the rotation moment applied to the turning member with its own weight is reduced by the rotation moment applied to the turning member with the urging means.

The turning structure with a turning member and a base member according to the present invention is arranged that the turning member for tuning is attached to the base member so that the turning member is operated to turn relative to the base member and is provided with a resistance providing means for providing resistance against the turn of the turning member relative to the base member and with an urging means for urging the turning member relative to the base member.

The urging means is to urge the turning member relative to the base member when the turning member turns relative to the base member, to create, in at least part of the possible turning range of the turning member relative to the base member, a region in which the rotation moment applied to the turning member by its own weight is reduced by the rotation moment applied to the turning member by the urging means.

Incidentally in the appended claims, the phrase ‘is reduced’ refers to the case in which the rotation moment applied to the turning member by the weight of the turning member itself is greater than the rotation moment applied to the turning member by the urging force of the urging means and the former moment is reduced by the latter moment, to the case in which both of the moments are equal and offset each other, and to the case in which the former moment is smaller than the latter moment and the former moment is reduced by the latter moment.

While the present invention is broadly described above with some features, their constitutions and contents together with objects and other features will become more apparent in reference to the disclosure below and appended drawings.

### BRIEF DESCRIPTION OF THE DRAWINGS

FIG. 1 is a perspective view of a note-size PC in which the turning structure, or a top cover opening and closing device, as an embodiment of the present invention is employed.

FIG. 2 is a side elevational view of the note-size PC with its top cover swung open.

FIG. 3 shows a vertical section near the first hinge device of the top cover opening and closing device.

FIG. 4 is an exploded view of a plastic-made friction member and a collar of the first hinge.

FIG. 5 shows a vertical section near the second hinge device of the top cover opening and closing device.

FIG. 6 is an oblique view of a torsion coil spring of the first hinge device.

FIG. 7 is an explanatory drawing of a top cover driving mechanism installed in the top cover opening and closing device.

FIG. 8 is an explanatory drawing of another example of gear train.

FIG. 9A is an explanatory drawing of a gear disengaging mechanism. FIG. 9B is an explanatory drawing of gears disengaged by the gear disengaging mechanism.

FIG. 10 is an explanatory drawing of an essential part of the connecting portion between the main body of an electric rice cooker and its top cover, as another embodiment in which the turning structure of the present invention is used as the top cover opening and closing device is used.

FIG. 11A is a simplified side view of the note-size PC for explaining a quick closing mechanism. FIG. 11B is an enlarged explanatory view of an essential part of an engaging portions of gears in a clearance securing area. FIG. 11C is an enlarged explanatory view of an essential part of a spring attachment portion having a spring holding area.

### DETAILED DESCRIPTION OF THE INVENTION

An embodiment of the present invention is described below in reference to the appended drawings.

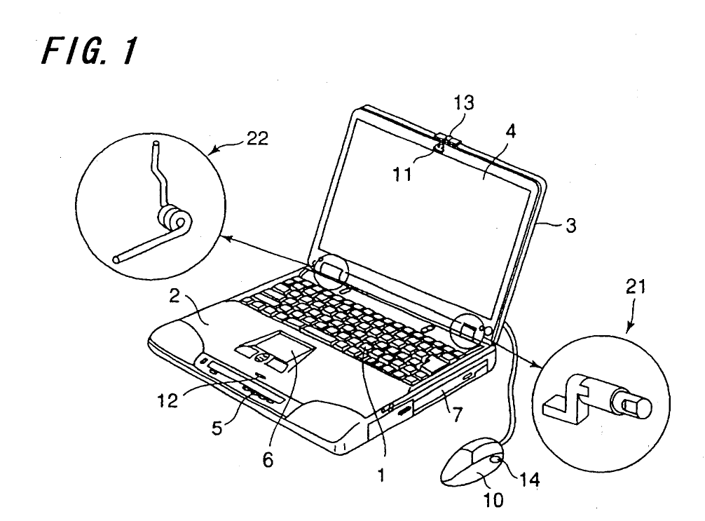

In this embodiment, the turning structure of the present invention is applied to a note-size PC. As shown in FIG. 1, a note-size PC comprises a main part 2 of a box shape, as a base member, with its top side provided with a keyboard 1, and a top cover 3 as a turning member hinged to the back edge portion of the main part 2.

The top cover 3 is hinged to the main part 2 so as to swing down and cover the top side of the main part 2 and to swing up and open up the top side of the main part 2.

The inside surface of the top cover 3 is almost entirely provided with a liquid crystal display screen 4 excluding only peripheral edges. The top side of the main part 2 is provided with various operation buttons 5 and a track pad 6 as well as the keyboard 1.

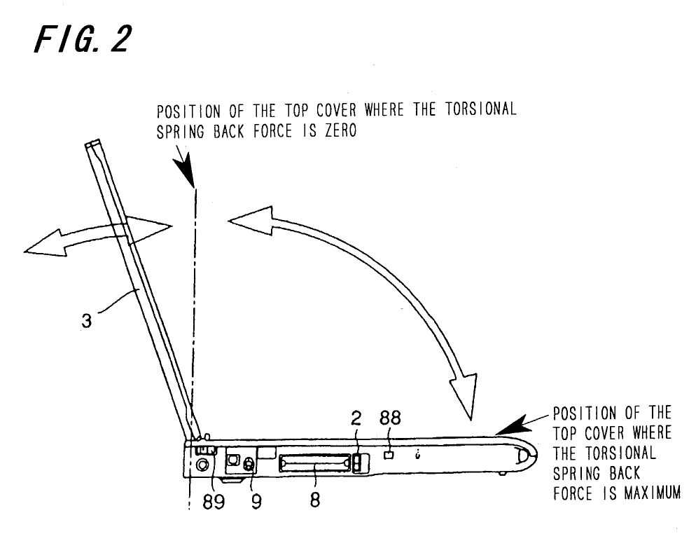

As shown in FIG. 2. a side of the main part 2 is provided with a CD-ROM drive 7, an FD drive 8, and various terminals 9. Besides, this PC has various functions as usual with the note-size PCs in general. When the top cover 3 is swung open, the PC may be operated by using the keyboard 1 or the mouse 10 while watching the display screen 4. The top surface of the main part 2 can be covered by swinging down the top cover 3.

The turning distal end of the top cover 3 is provided with a locking claw 11 to automatically engage with an engagement member 12 formed in the front top part of the main part 2 when the top cover 3 is closed. The turning end edge of the top cover 3 is provided with a lock releasing button 13 so that the locking claw 11 engage-stopped with the engagement member 12 is disengaged by sliding the lock releasing button 13 in one direction. The lock releasing button 13 returns to its original position when it is released after the lock releasing operation. A separate, slide prevention button may be provided as a matter of course to prevent the lock releasing button 13 from sliding unexpectedly by itself.

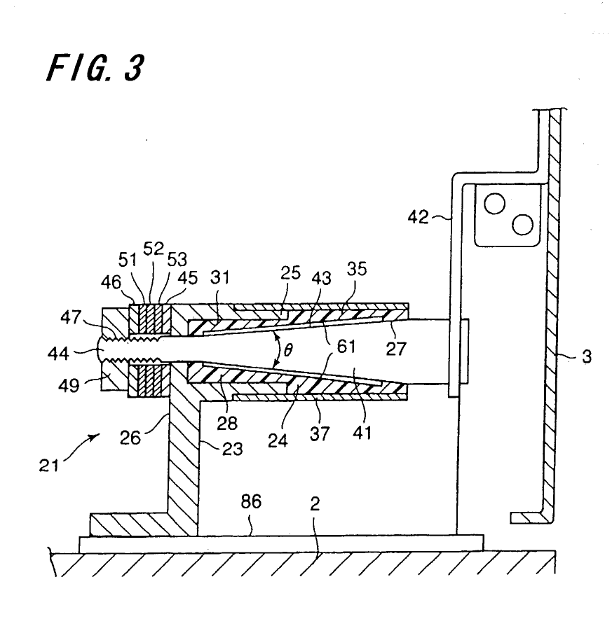

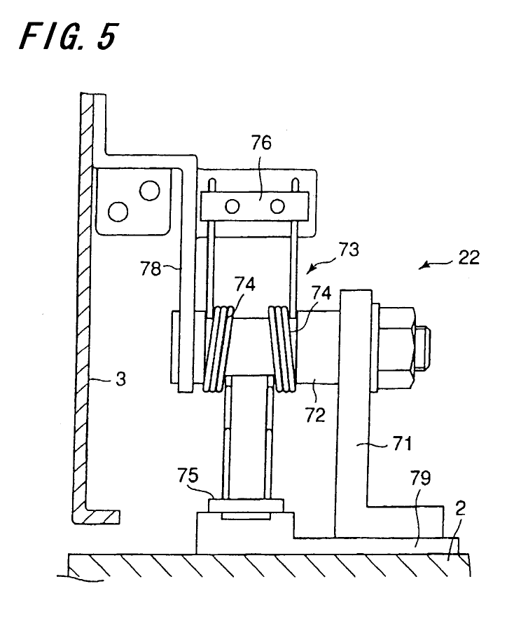

Right and left positions on the back edge portion of the main part 2 are coaxially provided with hinge devices 21 and 22 of different types as a pair, so that the top cover 3 is pivoted to open and close by means of the paired hinge devices 21 and 22. The first hinge 21 on the right hand is of a friction type as shown in FIG. 3 using a plastic-made friction member while the second hinge 22 on the left hand is of a spring type as shown in FIG. 5 using a torsion coil spring.

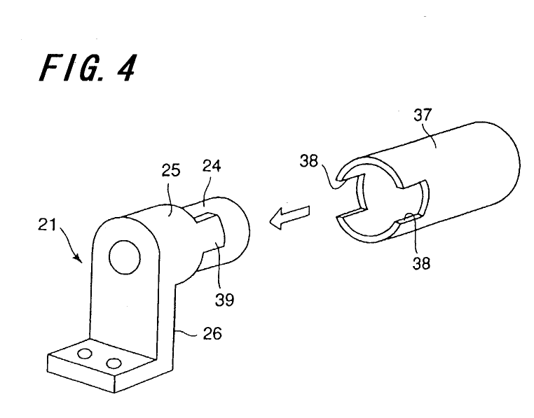

First, the first hinge 21 disposed on the right hand is described in reference to FIGS. 3 and 4. The first hinge 21 has a bearing main part (hinge body) 23, a zinc-die cast integral body, which is made up of a cylindrical holding portion 25 for holding a plastic-made friction member 24, and a leg portion 26 fixed to the main part 2 of the PC. The friction member 24 is made of a plastic material as a single body of a nearly cylindrical shape and has a tapered bearing hole 27. The base end portion 28 of the friction member 24 is fitted into a hole 31 formed in the holding portion 25 of bearing main part 23. The friction member 24 is fixed and held, so as not to rotate, to the bearing main part 23. Therefore, the round outside surface of the base end portion 28 is formed not in a true cylindrical shape but in a deformed shape.

Also as shown in FIG. 3, part of the plastic-made friction member 24 projects from the hole 31 formed in the holding portion 25, and the projecting end portion 35 is greater in diameter than the base end portion 28. A metallic collar 37 is tightly fitted around the area from the projecting end portion 35 to the holding portion 25 of the bearing main part 23 to prevent the area from swelling out. The metallic collar 37 is engage-stopped with the holding portion 25 so as not to rotate relative to the holding portion 25. That is to say, as shown in FIG. 4, the base end portion of the metallic collar 37 is provided with plural recesses 38 for engagement stop, and the outside circumferential area of the holding portion 25 for the metallic collar 37 to fit in is provided with plural projections 39 for engagement stop, so that the recesses 38 and the projections 39 engage with each other when the metallic collar 37 is fitted over the round surface of the holding portion 25. In this way, the metallic collar 37 is connected to and held with the holding portion 25 so as not to rotate.

As shown in FIG. 3, a metallic rotary shaft 41 for supporting the turning member, the top cover 3, is fitted into the bearing hole 27 of the friction member 24. The rotary shaft 41 is rotatably supported in the bearing hole 27 of the friction member 24 in the state of being closely fitted. A support frame 42 for supporting the top cover 3 is secured to the base end of the rotary shaft 41. The support frame 42 is secured to the top cover 3.

The rotary shaft 41 is made of an iron-based material such as stainless steel. The part of the rotary shaft 41 fitted closely into the bearing hole 27 is formed as a tapered outside round surface 43 to match the tapered shape of the bearing hole 27. The small diameter end 44 of the rotary shaft 41 extends from the friction member 24 side to pass through and project out of the holding portion 25. On to the projecting end 44 are fitted a main part securing washer 45 and a rotary washer 46. The small diameter end 44 of the rotary shaft 41 is formed with a male thread 47 onto which is screwed a tightening nut 49 to tighten up the rotary shaft 41 against the friction member 24. Urging members, or spring members, to be elastically pressed are interposed between the washers 45 and 46. The spring member is for example a coned disc spring, a kind of spring washer, and provided in a single or plural number as required. In the drawing are shown three coned disc springs 51, 52, and 53. The coned disc springs 51, 52, and 53 may be placed with the same sides directed in the same direction or directed in different directions by turns. The washers 45 and 46 are usually made of sheet metal, or any plastic material that is relatively strong and hard. The coned disc springs 51, 52, and 53 are made of spring steel or the like.

As the nut 49 is screwed over the male thread 47 of the rotary shaft 41, the rotary shaft 41 is pulled hard toward the nut 49, and the tapered round surface of the rotary shaft 41 is pressed against the inside tapered round surface of the bearing hole 27 of the friction member 24 and held in tight-pressed state. As the nut 49 is tightened, the coned disc springs 51, 52, and 53 are pressed and elastically deformed between the washers 45 and 46 as shown in FIG. 3 and held in the state of being in close contact with each other in a flat, compressed shape. The total spring force of the coned disc springs 51, 52, and 53 becomes a maximum when they are tightened to be a state of mutual contact over their entire surfaces. Usually they are tightened more than that state by setting the tightening force of the rotary shaft 41 against the friction member 24 for example to about 120% of the total spring force of the coned disc springs 51, 52, and 53.

Usually, since the securing washer 45 is fixed to the holding portion 25 while the rotary washer 46 turns together with the rotary shaft 41, the washers 45 and 46, and the coned disc springs 51, 52, and 53 interposed between the washers 45 and 46 slip relative to each other, so that the rotary shaft 41 turns smoothly.

Incidentally, the taper angle θ of the bearing hole 27 of the plastic-made friction member 24 is from 10 to 25 degrees, preferably 14 degrees. The taper angle of the outside tapered surface of the rotary shaft 41 is set to match the taper angle θ of the bearing hole 27. Both of the taper angles are permissible as long as both components can be fitted together and need not be in strict agreement.

The tapered inside surface of the bearing hole 27 of the plastic-made friction member 24 is provided with grease holding grooves 61. While the grease holding grooves 61 here are formed in fine grooves parallel to the axis of the plastic-made friction member 24, they may otherwise be formed obliquely. The cross-sectional shape of the grease holding groove 61 is for example a V. The grease holding grooves 61 hold lubricant, grease. The grease holding grooves 61 are provided in a limited area, of the inside tapered surface of the bearing hole 27 of the plastic-made friction member 24, the tapered round surface of the rotary shaft 41 comes into contact with.

The first hinge 21 is assembled as shown in FIG. 3 by fitting the friction member 24 and the collar 37 over the rotary shaft 41 and tightening up the rotary shaft 41 with the nut 49. The tightening force caused with the nut 49 and the coned disc springs 51, 52, and 53 is transmitted through the tapered round surface of the rotary shaft 41 to the friction member 24, and tends to cause the friction member 24 to swell. However, since the metallic collar 37 is fitted over the round outside surface of the friction member 24, the friction member 24 is prevented from swelling. Therefore, the tightening force works effectively and the press-contacting force between the friction member 24 and the rotary shaft 41 is enhanced. Therefore, the friction member 24 itself produces a strong elastic function and sufficient spring effect. Besides, the plastic-made friction member 24, though a thin-walled, compact component, produces strong spring effect and sufficient elastic function.

As the tapered inside surface of the friction member 24 and the tapered outside surface of the rotary shaft 41 are pressed hard against each other by the wedge effect, slide frictional force increases to produce a resistance force required of the rotary shaft 41 when the rotary shaft 41 is turned. Therefore, the friction member 24 and the rotary shaft 41 serve as a resistance providing means for providing resistance against the turn of the top cover 3 of the main part 2 of the PC.

Here, the grease held in the grease holding grooves 61 seeps into the gap between the friction member 24 and the rotary shaft 41 to form a grease film in the gap. Therefore, even if the friction member 24 and the rotary shaft 41 are tightened hard, they do not stick tight to each other and the rotary shaft 41 is not hindered from turning. In other words, it cannot occur that the resistance against the turn of the rotary shaft 41 is too strong or that the rotary shaft 41 is stuck and immovable. And an appropriate resistance feeling with an appropriate resisting force is provided in a stabilized manner. At the same time, a locking function is provided so that the rotary shaft 41 can be stopped and held in any rotary position of the rotary shaft 41 made of metal.

Here, in the case the friction member 24 deteriorates and its spring-back force weakens, the coned disc springs 51, 52, and 53 expand accordingly to automatically supplement the tightening force to be applied to the rotary shaft 41. As a result, the rotary frictional force is maintained for an extended period of time. Therefore, the rotary frictional force of the first hinge 21 does not weaken semi-permanently so to speak, and so its readjustment is unnecessary. Readjustment work by re-tightening the nut 49 is also unnecessary. Therefore, the product is improved in durability and reliability. With the hinge 21, since the resistance feeling is provided with the surface pressure between the all-plastic-formed friction member 24 and the rotary shaft 41, smoothness of turn remains semi-permanently so to speak.

Incidentally, the resistance providing means is not limited to the above embodiment comprising the shaft 41, and the friction member 24 for producing frictional resistance by turning relative to the shaft 41, but any arrangement may be employed appropriately as long as the arrangement produces rotary resistance against the turn of the top cover 3 relative to the base member, the main part 2 of the PC.

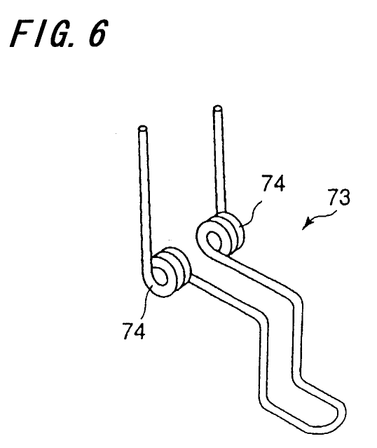

Next, the second hinge 22 disposed on the left hand is described in reference to FIGS. 5 and 6. The second hinge 22 is made up of a leg member or a shaft supporting body 71 secured to the main part 2 of a PC and a shaft 72 supported with the shaft supporting body 71. An urging means, a torsion coil spring 73, shown in FIG. 6 is disposed around the shaft 72. As the shaft 72 passes through the winding portion 74 of the torsion coil spring 73, the torsion coil spring 73 is supported for free turn around the shaft 72. As the shaft 72 is placed coaxially with the axis of the first hinge 21, the axis of the winding portion 74 of the torsion coil spring 73 is also placed coaxially with the axis of the first hinge 21.

The torsion coil spring 73 of this embodiment is of a type with twin, right and left, symmetric winding portions 74 made of a single spring material wire. The right and left winding portions 74 are wound in mutually opposite directions to produce torsional spring back force. One side ends of the winding portions 74 of the torsion coil spring 73 are secured through a securing fitting 75 to the main part 2 of the PC. The other side ends of the torsion coil spring 73 are secured with a separate securing fitting 76 to a support frame 78 for securing the top cover 3. The shaft supporting body 71 and the securing fitting 75 are secured to a unit base 79 which in turn is attached to the main part 2 of the PC.

The support frame 78 is pivoted with one end of the shaft 72. Alternatively, the support frame 78 may be secured to the shaft 72 which in turn may be pivoted with the shaft supporting body 71. With the latter arrangement, the support frame 78 need not be pivoted with the shaft 72. Or, both of them may be pivoted as a matter of course.

The torsion coil spring 73 serves as an elastic means for urging the top cover 3 in the swing opening direction about the shaft 72. In other words, as shown in FIG. 2, the spring back force of the torsion coil spring 73 works to give a rotation moment in the direction of raising the top cover 3 toward upright position. When the top cover 3 is turned beyond the upright position to about 120 degrees, a torsional spring back force is produced with the hinge 22 in the direction of returning to the upright position.

Incidentally, while this embodiment is arranged that the torsion coil spring 73 has twin winding portions 74, it may also be arranged to have a single winding portion 74.

The top cover 3 is rotatably supported at the back edge of the main part 2 of the PC by means of the coaxial, paired right and left hinges 21 and 22.

Next, how the top cover 3 is opened or closed is described. When the note-size PC is not in use, the top cover 3 is closed with the locking claw 11 in a locked state, a state of being engage-stopped with the engagement member 12. When the note-size PC is to be used, first the locking claw 11 is released from the engagement member 12 as the lock releasing button 13 located at the front edge of the top cover 3 is slid in the releasing direction. Then, the top cover 3 is brought to a standby state ready to be opened. And the top cover 3 may be opened by hand. And the PC may be used after the power switch is turned on and programs are started up. When the top cover 3 is to be closed after using the PC, first the programs are finished and the top cover 3 is closed. In the course of the top cover 3 being completely closed, the locking claw 11 is engage-stopped with the engagement member 12. After that, the top cover 3 remains locked until the PC is used again.

Next, functions that are characteristic of opening and closing the top cover 3 are described. The top cover 3 is pivoted to be opened or closed as required at the back edge of the main part 2 of the PC by means of paired right and left hinges 21 and 22 to turn about the same axis. The lateral distance of the center of gravity of the top cover 3 from the turning center of the top cover 3 changes according to the opening angle of the top cover 3, to be farthest when the top cover 3 is closed, and to decrease as the top cover 3 is raised toward upright attitude. Therefore, the rotation moment by the weight of the top cover 3 itself changes with the angular position of the raised top cover 3 and accordingly the force required to hold the top cover at any raised position also changes. That is, a greater holding force is required when the top cover 3 is near the closed position than near the upright position.

Here, since the first hinge 21 is of a friction type to hold the top cover 3 in any turned up position by frictional force, the frictional force is constant irrespective of the angular, raised position of the top cover 3. When this type of hinge 21 only is to be used, the frictional force is to be set to match the holding force required when the top cover 3 is near the closed position. Providing the holding force with the frictional force only will end up in a large frictional force and heavy operation of opening and closing the top cover 3.

However, according to this invention, it is arranged that the rotation moment produced with the weight of the top cover 3 itself is balanced as practicable as possible with the torsional spring back force of the torsion coil spring 73 of the second hinge 22 disposed on the left hand. This arrangement greatly reduces the share of frictional force with the first hinge 21. In other words, since the torsion coil spring 73 of the second hinge 22 urges the top cover 3 in the direction of swing opening and balances the rotation moment produced with the weight of the top cover 3 itself, the share of frictional force of the plastic-made friction member 24 of the first hinge 21 decreases. As a result, the frictional holding force of the first hinge 21 may remain small and the top cover 3 may be opened and closed smoothly with a light force.

Besides, the second hinge 22 is of a type that axially supports the top cover 3 to be turned with a light force and is arranged to urge the top cover 3 to open by swinging about the shaft 72 by the torsional spring back force of the torsion coil spring 73, and to give rotation moment to the top cover 3 in the direction of swinging toward the upright position as shown in FIG. 2. Here, the torsional spring back force of the torsion coil spring 73 varies with the angular position of the top cover 3. That is, the amount of twist, and so the torsional spring back force, of the torsion spring 73 is the greatest when the top cover 3 is closed. As shown in FIG. 2, the twist amount of the torsion spring 73 decreases in the course of opening the top cover 3. Since the torsional spring back force is set to be a minimum when the top cover 3 is opened upright, there is no waste in the urging force of the torsion spring 73. The urging force of the torsion coil spring 73 is counteractive to the rotation moment produced with the weight of the top cover 3 itself, balancing each other, when the top cover 3 is in the course of being opened or closed. The rotation moment produced with the weight of the top cover 3 itself is theoretically zero when the top cover is upright, and increases as the top cover 3 is tilted down gradually from the upright position.

In other words, as shown in FIG. 2, as the top cover 3 is closed from the upright position to the zero-degree, closed position, the rotation moment by the weight of the top cover 3 itself increases. Therefore, it is possible to produce the torsional spring back force of the torsion coil spring 73 to counteract the rotation moment caused by the weight of the top cover 3 itself, and arrange that the operational force for turning the top cover 3 is zero or almost zero. Therefore, the first hinge 21 has only to produce a frictional force that can stop and hold the top cover 3 at any angle.

Also as shown in FIG. 2, the torsional spring back force of the torsion coil spring 73 of the second hinge 22 for urging the top cover 3 to open is designed to be zero when the top cover 3 is opened to the upright position, at 90 degrees from the main part 2 of the PC. It is arranged that a maximum torsional spring back force is applied to the top cover 3 when the top cover 3 is completely folded down, the weight of the top cover 3 is supported with the torsional spring back force of the torsion coil spring 73 of the second hinge 22, so that the weight of the top cover 3 felt by hand in any turning position is balanced to almost zero.

Furthermore, with the torsional spring back force designed to be zero with the top cover 3 in upright position, if the top cover 3 is turned beyond the upright position, to an angle of 100 or 120 degrees, a torsional spring back force is produced in the direction of bringing the top cover 3 back to the upright position. That is, the gravitational force acting on the top cover 3 over the range from the folded state to the upright state of the top cover 3 (or in the reverse order) is almost balanced with the torsional spring back force of the torsion coil spring 73.

Therefore, the first hinge 21 disposed opposite the torsion coil spring 73 has only to stop the top cover 3 at any required position. Therefore, the first hinge 21 of a small size having a small rotary frictional force suffices for the purpose. The frictional holding force produced with the plastic-made friction member 24 of the first hinge 21 may be small and so the burden on the first hinge 21 may be reduced. This makes it possible to arrange that the first hinge 21 is provided only on the right or left hand side, not on both sides, of the main part 2 of the PC. Moreover, since the frictional holding force of the friction member 24 of the first hinge 21 can be reduced, the service life of the first hinge 21 n be more than doubled, or the first hinge 21 can be made small in size and weight.

Moreover, the second hinge 22, of the type using the torsion coil spring 73, is very simple in constitution in comparison even with the first hinge 21, and can be made at a cost less than half that of the conventional hinge. Even in the case one pair of hinges are used respectively on the each side of the top cover 3 to stabilize the opening and closing action of the top cover 3, the hinges may be made in a small size at a low cost. Therefore, the reliability of the product is greatly improved and feeling of high quality can be provided at a low cost.

With the opening and closing device assembled as shown in FIG. 2, the top cover 3 can be turned with a very light force and, unlike with the conventional device, the main part 2 of the PC located below is not lifted together with the top cover 3 when it is lifted by hand. It can be said that the top cover 3 may be lifted with ease even by a single hand and stopped at any position, which is an improvement in the opening and closing operation of the top cover 3. Another advantage is that the hinge of the type of the first hinge 21 using the plastic-made friction member 24 need not be provided on both right and left sides, which leads to a simplified constitution.

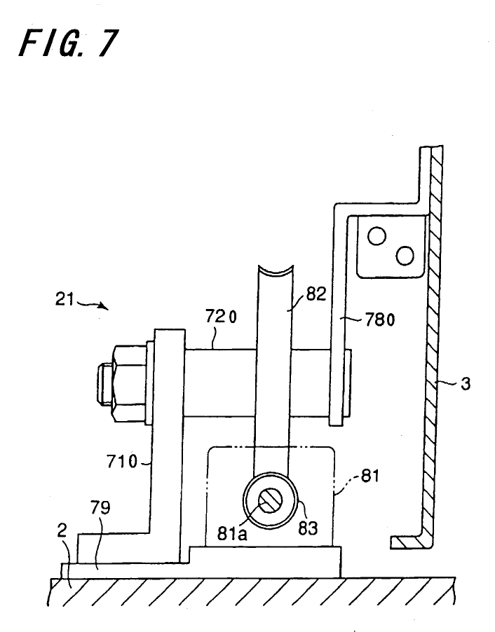

The present invention may also be applied to a top cover driving mechanism using an electric motor 81 (shown in FIG. 7) on the side of the main part 2 of the PC to open and close the top cover 3. In that case, while the first and second hinges 21 and 22 may be used as they are to axially support the top cover 3, it is preferable to constitute the hinges as described below.

That is, the second hinge 22 is used as it is on one side of the top cover 3. The hinge on the other side of the top cover 3 is arranged as shown in FIG. 7 to be made up of a shaft support member 710 secured as a leg member to the main part 2 of the PC and a shaft 720 supported rotatably with the shaft support member 710. A frame 780 for securing the top cover 3 is secured to the shaft 720. The shaft 720 for turning together with the top cover 3 is connected to the electric motor 81 provided on the main part 2 side of the PC through a power transmitting mechanism, or a speed reduction gear train. As shown in FIG. 7 for example, a worm wheel 82 is attached to the exposed portion of the shaft 720 of the first hinge 21 to engage with a worm gear 83 attached to the output shaft 81a of the motor 81. The gear train made up of the worm wheel 82 and the worm gear 83 is a speed reduction mechanism to step down the revolution of the motor 81 and to step down the turning speed of the top cover 3 when it is opened and closed, and to increase the driving force of the top cover driving mechanism. The speed reduction gear train serves as a locking mechanism for holding the top cover 3 at any turned position. Since the gear train here is made by direct engagement of the worm wheel 82 and the worm wheel 83, the reduction ratio is high. Since the worm gear 83 is directly attached to the output shaft 81a of the motor 81, the gear train is made compact, and so the top cover driving mechanism and the surrounding parts are also made compact.

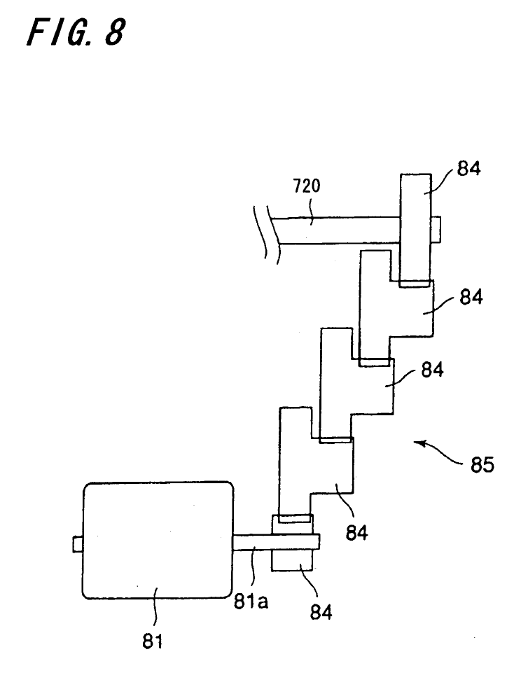

The power transmitting mechanism may be of any type as long as it can transmit power by interconnecting the motor 81, a driving member, and the shaft 720 provided on the top cover 3. The transmitting member may be made up for example of plural connecting members. The plural connecting members may be the worm wheel 82 and the worm gear 83 constituting the gear train. In the case a gear train is used to interconnect the shaft member turning together with the top cover 3 and the output shaft 81a of the driving motor 81, the gear train may be as shown in FIG. 8 a spur gear train 85 using a number of spur gears 84. Though not shown, using bevel gears for the gear train, the directions of gear axes may be changed as required. The plural interconnecting members may be for example of the friction transmission type or belt transmission type, or their combination, to transmit the turn-driving power of the driving motor 81 to the top cover 3. By interposing a drag mechanism in the transmission system, any excessive external force applied to the top cover 3 can be made ineffective. Incidentally, the friction transmission type or the belt transmission type itself is a drag mechanism.

The transmitting member may be of any type that receives the rotation of the motor 81, reduces its speed, and turns the shaft 720 attached to the top cover 3 at a reduced speed. And the transmitting member can be used as the reduction mechanism.

The top cover driving mechanism such as the motor 81 and the gear train or the like is usually made into a unit together with the first hinge 21, and attached through a unit base 86 to the main part 2 of the PC. The unit may be placed in an unused space on the main part 2 side of the PC.

The top cover driving mechanism may further be arranged that the lock releasing button 13 of the locking claw 11 mounted in the distal end portion of the top cover 3 also serves as a power source operation button. For example, power is turned on by sliding the lock releasing button 13 in the releasing direction. That is, when the lock releasing button 13 is slid to open the top cover 3, the power source switch is turned on, and the motor of the top cover driving mechanism starts operation. It may also be arranged that the PC is started up at the same time.

Incidentally as a matter of course, a slide preventing button may also be provided separately to prevent the lock releasing button 13 from sliding accidentally. It may also be arranged that the mouse 10 is provided with an operation button 14 that can be operated by hand when operating the mouse 10.

Next, the functions of the note-size PC are described. When the note-size PC is not in use, the locking claw 11 is in engagement with the engagement member 12, in the locked state.

To use this type of note-size PC provided with the top cover driving mechanism, first the lock releasing button 13 at the front end edge of the top cover 3 is slid to the releasing direction to disengage the locking claw 11 engaging with the engagement member 12. Then, the top cover 3 becomes ready for being opened. Since the lock releasing button 13 serves also as the power source operation button, the power source of the PC is turned on simultaneously with the slide of the lock releasing button 13, and the PC starts up. At the same time, the motor 81 of the top cover driving mechanism starts operation, and the top cover 3 starts opening. The lock releasing button 13, when the hand is removed from it at the time the top cover 3 starts opening, returns automatically to its original position.

The rotation speed of the motor 81 is reduced through its output shaft 81a, the worm gear 83, and the worm wheel 82. Increased driving force is transmitted to the shaft 720 of the first hinge 21, and the shaft 720 turns together with the top cover 3, so that the top cover 3 is opened as shown in FIG. 2. The amount of turning the top cover 3 is set to come to an end when the top cover 3 is opened for example to the position shown in FIG. 2. The turn end position of the top cover 3 may be determined by controlling the turning amount of the motor 81 using a preset value pre-stored in the PC. Alternatively, it may be arranged that a limit switch for detecting the turn end position of the top cover 3 is provided near the back edge of the main part 2 of the PC to detect the turn end position of the top cover 3 and to stop the operation of the motor 81. Or, both of the two arrangements may be used.

When the use of the note-size PC is to be finished, the top cover 3 is closed and programs enter the ending operation. With the program ending operation, the motor 81 of the top cover driving mechanism starts operation to automatically close the top cover 3. It may also be arranged otherwise as shown in FIG. 2 that a special switch button 88 for the top cover 3 is provided on a side of the main part 2 of the PC, so that the switch button 88 may be operated after the programs are over, to start the closing action of the top cover 3. An ordinary power source switch 89 may also be used as a matter of course.

When the top cover 3 is completely closed, the locking claw 11 engages with the engagement member 12. Thereafter the top cover 3 remains locked and closed until the PC is used again. As described above, the top cover 3 can be automatically opened or closed according to the start or end of use of the note-size PC.

Since the top cover driving mechanism has the function of a locking mechanism for holding the top cover 3 at any turned position, the top cover 3 need not be held with a frictional means utilizing the hinge of the top cover 3 or the like. Therefore, the hinge can be simplified. Besides, since a small force suffices for opening or closing the top cover 3, a small motor suffices for that purpose. A force that suffices for stopping the top cover 3 together with a liquid crystal screen at any turned position is obtained by reducing the rotation speed of the small motor. Stopping the top cover 3 securely at any required angle is possible by the use of a worm gear in the final state of the gear train. It is also possible to arrange various electric circuits to open and close the top cover 3 provided with the liquid crystal display and fine-adjust frequently used angles in the range of 100 to 130 degrees, and start up or end the software automatically when the top cover 3 is opened or closed. The use of the small motor makes manual opening and closing action unnecessary. Opening and closing action at a constant speed gives high quality impression. Feeling of resistance is given by the motor torque and the reduction gear ratio. Service life may be elongated by choosing the strength of respective gears.

In the case the built-in battery of the note-size PC runs down when the top cover 3 is open and cannot be closed, it can be closed by charging the battery. In the case a charger is unavailable, a mechanism that can simply disengage the final gear from outside or can turn the gear using a screwdriver may be provided, so that the device can be used safely.

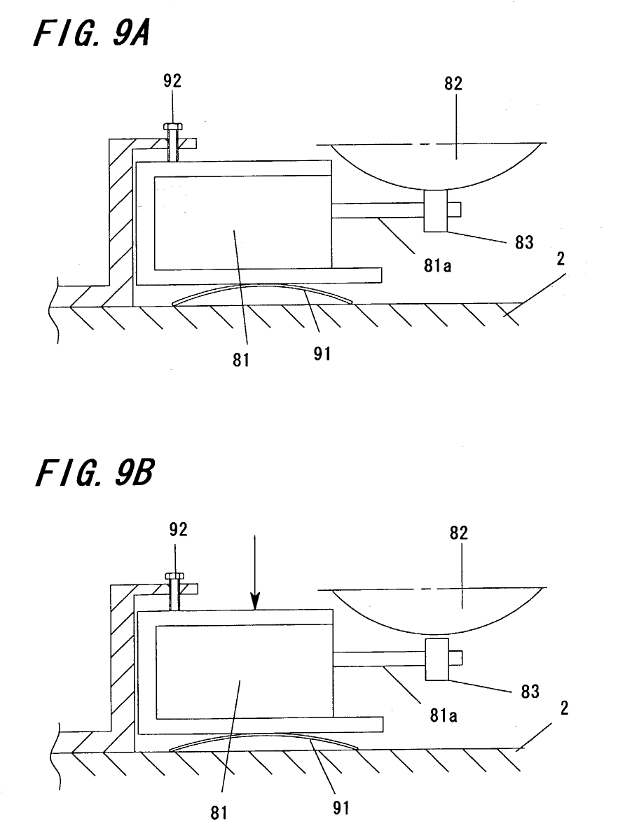

An example of disconnecting means, for mutually disconnecting connection members such as gears mutually connected for transmitting rotation, is shown in FIGS. 9A and 9B. The disconnecting means shown in FIGS. 9A and 9B is arranged that the motor 81 is attached to the main part 2 of the PC to move the second connection member, the worm gear 83, attached to the motor 81 vertically to and from the first connection member, the worm wheel 82, attached to the top cover 3. In this way, the worm gear 83 is made movable toward and away from the worm wheel 82. A curved plate spring 91, a connecting urging member, is provided between the motor 81 and the main part 2 of the PC to urge the worm gear 83 upward toward the worm wheel 82 through the motor 81. It is also arranged that the vertical position of the motor 81 can be adjusted in position by means of a bolt 92, a stopper, that holds the worm gear 83 in a position disconnected from the worm wheel 82, so that the worm gear 83 attached to the motor 81 smoothly engages with the worm wheel 82.

In the case the motor 81 becomes unable to rotate, the motor 81 can be pressed down against the urging force of the plate spring 91 by screwing down the bolt 92. In this way, as shown in FIG. 9B, the worm gear 83 moves down together with the motor 81 to disengage from the worm wheel 82. In this state, the rotary resistance of the worm wheel 82 is small and so the top cover 3 can be turned and closed by hand.

Even in the case an unexpected external force is exerted to the top cover 3 and further through the worm wheel 82 to the worm gear 83, and the force is transmitted from the worm gear 83 to the motor 81, the motor 81 can move down against the urging force of the plate spring 91. In this way, the gears 82 and 83 are disengaged from each other, so that the top cover 3 can be turned. Therefore, the gears 82 and 83, and the motor 81 are prevented from being damaged.

Incidentally, the motor 81 may be arranged not only to be pressed down by screwing down the bolt 92 against the plate spring 91 but also for example to be pressed down by hand, so that the worm gear 83 is moved down.

Besides, the top cover 3 of any PC can be stopped and held at any required angle by changing the gear ratio, force amplification ratio, and motor torque according to the size and weight of the top cover 3 provided with a liquid crystal display.

This type is beneficial to small, mobile, note-size PCs with a small-size casing having insufficient room for attaching a small motor. It is applicable as a matter of course to A4 note-size PCs. Manual opening and closing actions are eliminated. Motor-operated, constant speed opening and closing action gives a high quality impression. Service life is extended by choosing the gear strength of respective gears. Feeling of resistance is given by motor torque and gear ratio. The opening and closing device of the present invention greatly improves product reliability and provides high quality impression.

The urging means is not limited to the torsion coil spring 73 described above but may be any other spring such as a plate spring, or an air spring. For example, a plate spring or an air spring may be used to urge the top cover 3 relative to the main part 2 of the PC in place of or in addition to the torsion coil spring 73.

The above embodiment is arranged that the moment balancing region, the region in which the rotation moment acting on the top cover 3 by its own weight is balanced with the rotation moment acting on the top cover 3 with the spring back force of the torsion coil spring 73, is set over the entire movable range of the top cover 3 from the closed, nearly horizontal position at which the angle of the top cover 3 relative to the main part 2 of the PC is zero to the position open by about 120 degrees. However, the invention is not limited to the above example but the moment balancing region may be set to at least part of the movable range of the top cover 3.

For example, the spring back force of the torsion coil spring 73 is set to become zero when the top cover 3 is opened beyond the upright position relative to the main part 2 of the PC, and the moment balancing region is set over a range from the nearly horizontal position to the upright position of the top cover 3. Or, the spring back force of the torsion coil spring 73 is set to become zero when the top cover 3 is opened by 45 degrees and the moment balancing region is set to the range from the nearly horizontal position to about an angular position of 45 degrees.

When the hinge uses the torsion coil spring, it may be arranged that the hinges are placed on the right and left parts of the top cover to hold balance and the power transmitting mechanism of the top cover driving mechanism is placed between the two hinges. In this way, the top cover turning action is well balanced with respect to right and left hinges in a stabilized manner.

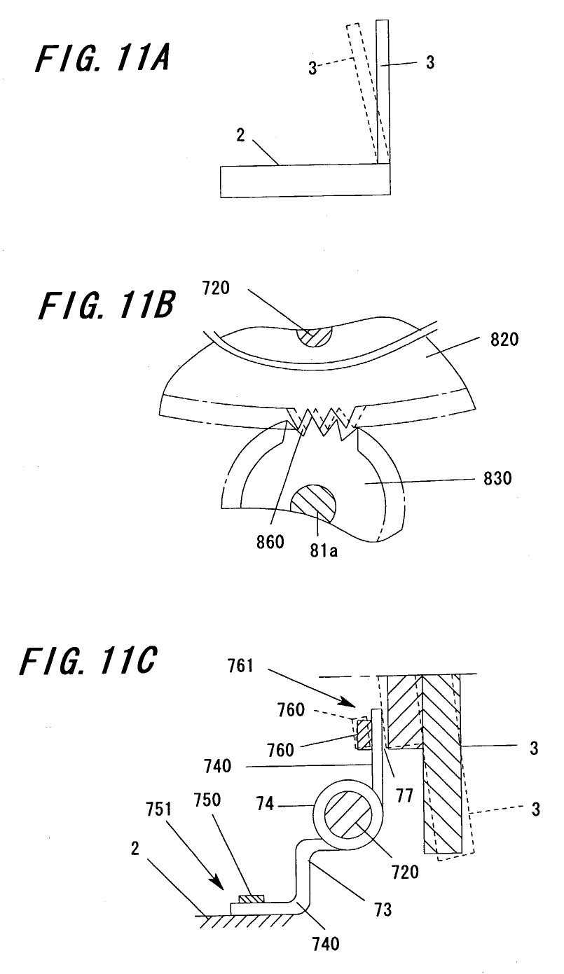

A quick closing means may be provided to close the top cover 3 at a fast speed. For example, the quick closing means is arranged as follows: As shown in FIGS. 11B and 11C, an arrangement is made that a power transmitting gear 830 attached to the out put shaft 81a of the motor 81 and a power receiving gear 820 attached to the shaft 720 of the top cover 3, constituting a gear train, are connectable with an intermediate clearance 860. And in a top cover spring support area 761, the top end of the torsion coil spring 73 is supported with a support member 760 on the top cover 3, with an intermediate clearance 77.

In this way, for example when the motor 81 is operated from the state of the top cover 3 being open by about 120 degrees from the main part 2 of the PC, the rotation of the output shaft 81a is transmitted from the power transmitting gear 830 to the power receiving gear 820 to turn the top cover 3 in the closing direction.

And as shown in FIG. 11A, when the top cover 3 turns past the upright position and the rotation moment by the weight of the top cover 3 itself begins to act on the top cover 3, the top cover 3, as shown with broken lines in FIGS. 11A and 11C, turns by an amount corresponding to the clearance 77 of the top cover spring support area 761, not by the rotation of the power transmitting gear 830 but by the rotation moment produced by the weight of the top cover 3 itself. In this way, it is possible to close the top cover 3 quicker than the rotation speed caused with the motor 81. Moreover, as shown with broken lines in FIG. 11B, the presence of a clearance 860 between the power receiving gear 820 and the power transmitting gear 830 makes it possible for the power receiving gear 820 to rotate freely without contacting the power transmitting gear 830 and without receiving rotary resistance from the power transmitting gear 830. As a result, the power receiving gear 820 turns faster, with the rotation moment produced with its own weight, than the power transmitting gear 830 by a difference corresponding to the clearance 860. As a result, it is possible to turn the top cover 3 all the more faster by turning it faster than the power transmitting gear 830.

The quick closing means is not limited to the above arrangement constituted by the mutual engagement of the gears 830 and 820 with the intermediate clearance 860 and the spring support area 761 having the clearance 77 but may be appropriately changed for example to an arrangement with only the spring support area 761 having the clearance 77. However, the above embodiment is preferable: The above embodiment, in comparison with an arrangement with only the spring support area 761, constitution by the mutual engagement of the gears 830 and 820 with the intermediate clearance 860 makes it possible to turn the top cover 3 faster than the power transmitting gear 830 according to the amount of the clearance 860 present between the gears 830 and 820 when they are engaged, and the top cover 3 can be closed all the more faster.

The arrangement may be made otherwise in which the clearance 77 is not provided in the spring support area 761 but in a main part spring support area 751 where the lower end of the torsion coil spring 73 is supported with a support member 750 on the main part 2 of the PC, or in both of the spring support area 761 and the main part spring support area 751. Incidentally, the spring support area 761 and the main part spring support area 751 may be arranged to support part or whole of arms 740, 740 projecting radially outward from the winding portion 74 of the torsion coil spring 73. Therefore, the end portion supported with the spring support area 761 or the main part spring support area 751 includes the end portion and the area near the end portion.

The clearance 860 may also be provided in one or more than one of the connecting portions between the output shaft 81a of the motor 81 and the power transmitting gear 830, between the gears 830 and 820, and between the power receiving gear 820 and the shaft 720 of the top cover 3. In the case three or more gears are used, it may be arranged to provide clearance in one or more connecting portions.

While the above embodiment is described as the turning structure of the present invention is applied to the note-size PC, the subject of application is not limited to the note-size PC but may be various products such as an electric rice cooker comprising a main part and a lid.

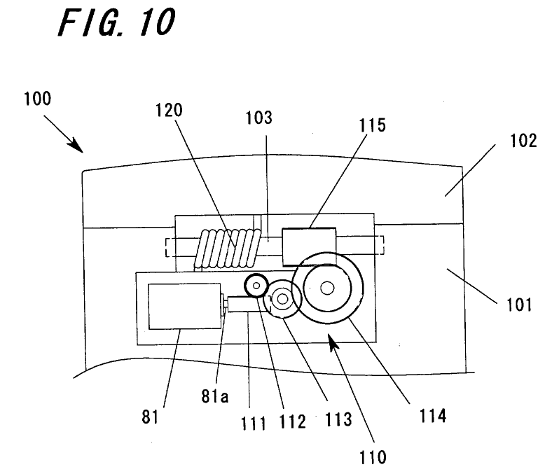

That is to say, as shown in FIG. 10, a lid 102, a turning member, and a main body 101, a base member, of an electric rice cooker 100 is made rotatable by means of a rotary shaft 103 secured to the lid 102. The rotary shaft 103 is provided with an urging means, a torsion coil spring 120.

A motor 81 having an output shaft 81a is attached to the main body 101 of the rice cooker. The output shaft 81a of the motor 81 and the rotary shaft 103 are interconnected for transmitting power through a power transmission mechanism, a gear train 110 made up of gears 111, . . . , 115. The gear train 110 is made as a speed reduction mechanism to turn the rotary shaft 103 at a speed reduced from the speed of the output shaft 81a of the motor 81.

As the opening switch (not shown) is operated, the motor 81 starts rotating in the normal direction to turn the rotary shaft 103 through the gear train 110. Thus, the lid 102 turns and opens relative to the main body 101 of the electric rice cooker. In this case too, an urging force of the torsion coil spring 120 acts on the lid 102 against the rotation moment that acts on the lid 102 by its own weight, and the power of the motor 81, with its rotation speed reduced with the gear train 110 and with its force increased, is applied to the rotary shaft 103. Therefore, the lid 102 can be opened with a small force an so it is possible to use a motor 81 of a small output that is easy to attach to the electric rice cooker 100 and that can be manufactured at a low cost.

The motor 81 stops rotating when its number of rotations reaches a specified value. This embodiment is arranged that a stop switch (not shown) may be operated to stop the motor 81 and the lid 102 at any appropriate position. In the case for example the stop switch is operated with the lid 102 in a position slightly above the closed position, the rotary shaft 103 of the lid 102 cannot be turned unless the gear train 110 is turned by applying a great force. Therefore, a great rotary resistance is given to the lid 102 by the gear train 110. And urging force of torsion coil spring is given to the lid 102 Therefore, even if the lid 102 is stopped at any arbitrary position, the lid 102 is prevented from closing by itself with the rotation moment produced with its own weight.

To close the lid 102 on the other hand, the motor 81 is started to rotate in the reverse direction by operating a closing switch (not shown), and the lid 102 is closed. The above is the description of the electric rice cooker provided with the turning structure according to the present invention.

The turning structure of the present invention is applicable to various turning devices made up of a turning member attached for turning on a base member. Such turning member and base member include for example: the body and lid of various electric appliances such as an electric thermos bottle, the body and lid of a stool, the body and folding part of a foldable bed, the base member and shelf attached to be foldable to the base member such as a wall, the base member and chair attached to be foldable to the base member such as a wall, and the body and lid of a copying machine.

The driving mechanism is not limited to the one made up of the motor 81 as the driving member and the transmitting member interconnecting the motor 81 and the top cover 3 for transmitting power but may comprise only the driving member without the transmitting member. For example, it may be arranged that the top cover 3 is provided with a connecting member for interconnecting the top cover 3 and the driving member for transmitting power and to drive the top cover 3 by the power of the driving member.

The turning structure of the present invention is arranged that the turning member is urged relative to the base member so as to create the region, in which the rotation moment applied to the turning member by its own weight is reduced by the rotation moment applied to the turning member by the urging means, in at least part of the range of turn of the turning member relative to the base member. Therefore, the rotation moment applied to the turning member by its own weight is reduced by the rotation moment applied to the turning member with the urging member when the turning member is turned relative to the base member. In this way, even when the weight of the turning member is great, the turning member may be turned with a small force. Therefore, the driving mechanism has only to transmit a small power to the turning member. Therefore, in the case for example a motor is used in the driving mechanism, the motor may be small in size, which facilitates installation and reduces the total weight.

The turning structure of the present invention is arranged that the base member and the turning member are respectively provided with the spring support area that supports the spring end, and that at least one of the spring support areas supports the spring with an intermediate clearance or play. Therefore, the turning member can turn by its own weight by an amount matching the play. Therefore, in the case for example a motor is used in the driving mechanism, the turning member is turned by its own weight in addition to the motor, so that the turning member is closed faster.

The turning structure of the present invention is arranged that the driving mechanism is made up of the motor and the power transmitting mechanism for transmitting the rotary power of the motor to the turning member, and the power transmitting mechanism is provided with the reduction mechanism for reducing the rotation speed of the motor and transmitting it to the turning member. Therefore, the power of the motor, with its rotation speed reduced and with its rotary force increased, is transmitted to the turning member. This makes it possible to appropriately set the rotary speed of the turning member relative to the base member. This also makes it possible to use a small motor to further reduce the size of the arrangement. On the other hand, while the motor remains still, the turning member is under a great rotary resistance by the power transmitting mechanism having the speed reduction mechanism. Therefore, even if the turning member is stopped at any arbitrary position, the turning member is prevented from turning by itself with its own weight and remains securely held in that position.

The turning structure of the present invention is arranged that the power transmitting mechanism is provided with plural connecting members capable of releasing at least one interconnection between the motor and the connecting member, between the connecting members, and between the connecting member and the turning member. This makes it possible, in the case the motor stops, to turn the turning member with reduced rotary resistance on the turning member. In the case an unexpected external force is exerted to the turning member at the time of turning the turning member, the connecting member is easily disconnected, so that the turning member can be turned. Therefore, the connecting member or the motor is prevented from being damaged.

The turning structure of the present invention is provided with the connection urging member for urging either the first or second connection member in the direction from the non-connectable position to the connectable position, so that the first and second connection members may be interconnected. In this way, in the case the first and second connection members are disconnected, they can return to an interconnected state by themselves.

The turning structure of the present invention is provided with the stopper for keeping either the first or second connecting member in the non-connectable position. Therefore, it is possible to keep the first and second connection members in the non-connectable position. In the case for example the motor stops, the turning member may be easily turned.

The turning structure of the present invention is arranged that the plural connecting members are provided with the worm and the worm wheel engaging with the worm to constitute the reduction mechanism, so that the power transmitting mechanism having the reduction mechanism can be easily formed.

The turning structure of the present invention is arranged that the plural connecting members are provided with the spur gear train having plural spur gears to constitute the reduction mechanism, so that the power transmitting mechanism having the reduction mechanism can be easily formed.

The turning structure of the present invention is arranged that at least one connection between the motor and connecting member, between two connecting members, and between the connecting member and turning member is made with intermediate play. If for example two connecting members are interconnected with play, one connecting member can turn freely without contacting the other connecting member and can turn faster than the other connecting member according to the play by the rotation moment caused by its own weight. As a result, the turning member can be turned faster.

The turning structure of the present invention is provided with the resistance providing means for giving rotary resistance against the turn of the turning member relative to the base member and the urging means for urging the turning member relative to the base member. Therefore, the rotation moment acting on the turning member by its own weight can be reduced with the urging means. In this way, the resistance given with the resistance providing means to the turning member that turns relative to the base member maybe small. Therefore, the turning member may be turned smoothly with a small force.

The turning structure of the present invention is arranged that the resistance providing means is made up of the shaft attached to one of the turning member and the base member, and the friction member attached to the other of the turning member and the base member. The friction member has the shaft hole for receiving the outside round surface of the shaft. The inside round surface of the shaft hole is provided with grease holding grooves to hold grease. When the shaft in the friction member turns, the grease held in the grease holding grooves seeps into the gap between the friction member and the shaft to form a grease film in the gap. Therefore, even if both of the components are tightened together, they do not stick tight and are not prevented from turning.

The turning structure of the present invention is provided with the driving mechanism for rotating the turning member by power, so the turning member need not be turned by hand, which makes the arrangement very convenient.

Besides, the present invention relates to a top cover opening and closing device, of a portable information processing apparatus comprising an information processing apparatus body and the top cover hinged to be opened and closed to the information processing apparatus body, made up of a top cover supporting hinge and a top cover driving mechanism; with the top cover supporting hinge provided with a torsion coil spring with its one end attached to the top cover side, with its other end attached to the information processing apparatus body side, to axially support the top cover, to be opened and closed, with the torsion coil spring giving an upward elastic urging force to the top cover, and with the top cover driving mechanism transmitting the power of an electric motor fitted in the information processing apparatus body to the top cover to be opened and closed through a speed reduction gear train.

The present invention also relates to a top cover opening and closing device for portable information processing devices, for axially supporting the top cover to be opened or closed as required by the use of a first hinge and a second hinge, with the first hinge made by press-fitting a shaft having a tapered round outside surface into the bearing hole having a tapered inside surface formed in a plastic-made friction member to axially support the top cover to be opened or closed as required while producing resistance by relative rotation between the tapered inside surface and the tapered round outside surface, with the second hinge having a torsion coil spring with its one end attached to the top cover side and with its other end attached to the information processing device body side to axially support the top cover to be opened or closed as required, and with the torsion coil spring urging the top cover in the opening direction of the top cover by imparting an elastic force to the top cover.

Besides, the inside surface of the bearing hole in the plastic-made friction member is provided with grease holding grooves for holding grease.

Besides, the top cover opening and closing device for the portable information processing apparatus is characterized by being provided with a top cover driving mechanism for opening and closing the top cover by transmitting the power of the motor fitted in the information processing apparatus through a power transmitting mechanism to the top cover.

The above constitution makes it possible to open and close the top cover of the information processing apparatus smoothly with a light, stabilized force. The present invention also makes it possible to greatly reduce the share of frictional holding force of the hinge utilizing friction, to reduce and make as constant as possible the force for opening and closing operation of the top cover, and to smoothly open and close the top cover of the information processing apparatus. Besides, since the top cover is opened and closed not by hand but with a small motor, the top cover opening and closing device may be used comfortably and its service life may be elongated.

While the present invention is described above by way of preferable embodiments, respective words and phrases are used not for the purpose of limitation but for illustration, and may be changed within the scope of the appended claims without departing from the scope and spirit of the present invention.

What is claimed is:

1. A turning structure of a base member and a turning member, with said turning member attached to the base member to be operated to turn as required, comprising:
an urging means for urging said turning member relative to said base member, and a driving mechanism for turning said turning member by power, and
wherein said urging means urges said turning member relative to said base member to be able to create a region in at least part of the range in which said turning member can turn relative to said base member, said region being such that the rotation moment acting on said turning member as produced by its own weight is reduced by the rotation moment produced by the urging force of said urging means.

2. A turning structure of a base member and a turning member according to claim 1, wherein said urging means is a spring provided between said turning member and said base member.

3. A turning structure of a base member and a turning member according to claim 2, wherein said spring is a torsion coil spring.

4. A turning structure of a base member and a turning member according to claim 2, wherein each of said base member and said turning member has a spring support area that supports the end of said spring, and at least one of said spring support areas supports said spring with an intermediate play.

5. A turning structure of a base member and a turning member according to claim 1, wherein said driving mechanism comprises an electric motor and a power transmitting mechanism for transmitting a rotary power of said electric motor to said turning member, and
wherein said power transmitting mechanism comprises a speed reduction mechanism that transmits the rotary power of said electric motor, at a reduced rotary speed, to said turning member.

6. A turning structure of a base member and a turning member according to claim 5, wherein said speed reduction mechanism comprises plural connecting members that are provided so as to transmit the power of said electric motor at the reduced rotary speed to said turning member.

7. A turning structure of a base member and a turning member according to claim 6, wherein said power transmitting mechanism is capable of releasing at least one of the interconnections between said electric motor and said connecting member, between two said connecting members, and between said connecting member and said turning member.

8. A turning structure of a base member and a turning member according to claim 6, wherein one of the first connecting member and the second connecting member, mutually connected, of said plural connecting members is made capable of moving relative to the other of the first connecting member and the second connecting member at least over a range from a connectable position to a non-connectable position to be non-connectable, and said first connecting member and said second connecting member can be disconnected from each other and can be connected with each other by said relative motion.

9. A turning structure of a base member and a turning member according to claim 8, further comprising a connection urging member for urging one of said first connecting member and said second connecting member in the direction from said non-connectable position to said connectable position, wherein said first connecting member and said second connecting member are made connectable by said connection urging member.

10. A turning structure of a base member and a turning member according to claim 9, further comprising a stopper for holding one of said first connecting member and said second connecting member in said non-connectable position.

11. A turning structure of a base member and a turning member according to claim 6, wherein said plural connecting members comprises a worm and a worm wheel engaging with said worm.

12. A turning structure of a base member and a turning member according to claim 6, wherein said plural connecting members comprises a spur gear train with plural spur gears.

13. A turning structure of a base member and a turning member according to claim 6, wherein at least one of the interconnections between said electric motor and said connecting member, between two said connecting members, and between said connecting member and said turning member, is made with intermediate play.

14. A turning structure of a base member and a turning member according to claim 1, wherein said base member is a main body of an electric apparatus and said turning member is a lid attached to be opened and closed as required to said main body.

15. A turning structure of a base member and a turning member according to claim 1, wherein said base member is the body of a portable information processing apparatus, and said turning member is the top cover attached to be opened and closed as required to said body of said portable information processing apparatus.

16. A turning structure of a base member and a turning member, with said turning member attached to the base member to be operated to turn relative to said base member as required, comprising:
a resistance providing means to apply resistance against the turn of said turning member relative to said base member, and an urging means for urging said turning member relative to said base member, and
wherein said urging means urges said turning member relative to said base member to be able to create a region in at least part of the range in which said turning member can turn relative to said base member, said region being such that the rotation moment acting on said turning member as produced by its own weight is reduced by the rotation moment produced by the urging force of said urging means.

17. A turning structure of a base member and a turning member according to claim 16, wherein said resistance providing means comprises: a shaft provided on one of said turning member and said base member: and a friction member provided on the other of said turning member and said base member,
said shaft, while in contact with said friction member, turns relative to said friction member when said turning member turns relative to said base member, and
said friction member gives frictional resistance against said shaft when said shaft turns relative to said friction member.

18. A turning structure of a base member and a turning member according to claim 17, wherein
said shaft has a tapered round outside surface,
said friction member has a bearing hole for receiving said round outside surface of said shaft, and
said resistance providing means comprises a press-urging member for urging to press together said round outside surface of said shaft received in said bearing hole and a inside surface of said bearing hole.

19. A turning structure of a base member and a turning member according to claim 18, wherein said inside surface of said bearing hole has grease holding grooves for holding grease.

20. A turning structure of a base member and a turning member according to claim 16, wherein said turning structure comprises a driving mechanism for turning said turning member by power.
